(19) United States
(12) Patent Application Publication
(10) Pub. No.: US 2011/0033649 A1
(43) Pub. Date: Feb. 10, 2011

(54) Package for Two-Way Mailing

(76) Inventor: Richard T. Brockway, II, Sacramento, CA (US)

Correspondence Address: CENTRAL COAST PATENT AGENCY, INC, 3 HANGAR WAY SUITE D, WATSONVILLE, CA, 95076, US

(21) Appl. No.: 12/581,441

(22) Filed: Oct. 19, 2009

Related U.S. Application Data
(60) Provisional application No. 61/232,100, filed on Aug. 7, 2009.

(51) Int. Cl. B65D 65/28; B31F 1/08; B32B 38/04

(52) U.S. Cl. 428/43; 156/211

(57) ABSTRACT

A form for creating a two-way mailer has a planar, rectangular sheet of foldable material having a left edge and a right edge defining a length substantially greater than a width, first, second, third and fourth regions disposed left to right successively on the sheet, the regions defined by first, second and third fold lines across the width of the sheet at right angles to the length, a first perforated tear-off line proximate the first fold line, a first glue region at the left edge of the sheet in the direction of the width dimension and joined to the sheet by a second perforated tear-off line, a second glue region at the right edge of the sheet in the direction of the width dimension, and a pattern of adhesive on the second region. The dimensions of the second and the third regions in the direction of the length of the sheet are substantially equal, dimension of the first region in the same direction is greater than that of any of the other regions, and the dimension of the fourth region in the same direction is less than that of any of the other regions, and the first and second glue regions are one of remoistenable glue or self-adhesive regions with a peel-off cover.

### CROSS-REFERENCE TO RELATED APPLICATIONS

The present invention claims priority to a U.S. provisional patent application Ser. No. 61/232,100, filed Aug. 7, 2009. The disclosure is included herein at least by reference.

### BACKGROUND OF THE INVENTION

1. Field of the Invention

The present invention is in the field of packaging and pertains particularly to methods and apparatus for providing a two way mailing package for mailing disks.

2. Discussion of the State of the Art

There is a need for a two-way disk mailer that will conform to the U.S. Postal regulations relating to the size, weight and shape of Automation-Compatible Folded Self-Mailers Containing Discs as set forth in the Domestic Mail Manual section 201 paragraph: 3.3.4 Dimensions and Shape Standards for Automation-Compatible Folded Self-Mailers Containing Discs. There are no two-way mailers at the time of this application that conform to this standard, while maintaining a total weight of 1 ounce or less.

Therefore, what is clearly needed is for a two-way disk mailer that can conform to the U.S. Postal regulations relating to the size, weight and shape of Automation-Compatible Folded Self-Mailers Containing Discs as set forth in the Domestic Mail Manual section 201 paragraph: 3.3.4 Dimensions and Shape Standards for Automation-Compatible Folded Self-Mailers Containing Discs.

### SUMMARY OF THE INVENTION

The problem stated above is that a package for two way mailing of computer-useable media such as compact disks or digital video disks that conforms to the U.S. Postal regulations relating to the size, weight, and shape of Automation-Compatible Folded Self-Mailers Containing Disks as set forth in the Domestic Mail Manual section 201 paragraph: 3.3.4 titled Dimensions and Shape Standards for Automation-Compatible Folded Self-Mailers Containing Disks is desirable, but none of the conventional means for mailing such media provide two-way mailing capability for the same package. The inventors therefore considered functional elements of a mailing package, looking for elements that exhibit reusability that could potentially be harnessed to provide a two way mailer but in a manner that would not create undue labor.

Every mailing package comprises some form of paper or plastic construction, one by-product of which is an abundance of waste that must be recycled or sent to landfill. Most such packages employ pre-folds and perforations including self-sealing adhesives to contain the product or products being mailed. Adhesive surfaces, perforations and pre-folds are typically a part of such apparatus.

The present inventor realized in an inventive moment that if, at the point of mailing, a package could be provided that could be used twice before discarding, and also conform to US Postal regulations for size and weight to qualify for the lowest postage, significant savings could result. The inventor therefore constructed a unique packaging arrangement for mailing computer disks and the like that allowed users to receive disks in the mail and send them or others back through the mail using the same package at the lowest postage rate. A significant cost reduction results, with no impediment to packaging or repackaging created.

Accordingly, in an embodiment of the present invention a form for creating a two-way mailer is provided, comprising a planar, rectangular sheet of foldable material having a left edge and a right edge defining a length substantially greater than a width, first, second, third and fourth regions disposed left to right successively on the sheet, the regions defined by first, second and third fold lines across the width of the sheet at right angles to the length, a first perforated tear-off line proximate the first fold line, a first glue region at the left edge of the sheet in the direction of the width dimension and joined to the sheet by a second perforated tear-off line, a second glue region at the right edge of the sheet in the direction of the width dimension, and a pattern of adhesive on the second region. The dimensions of the second and the third regions in the direction of the length of the sheet are substantially equal, dimension of the first region in the same direction is greater than that of any of the other regions, and the dimension of the fourth region in the same direction is less than that of any of the other regions, and the first and second glue regions are one of remoistenable glue or self-adhesive regions with a peel-off cover.

In one embodiment of the invention the dimensions of the second and the third regions in the direction of the length of the sheet are about 5.5 inches, and with the third region folded over the second region and adhered by the pattern of adhesive, provides for a pocket of a size to enclose a five-inch diameter planar disk. Also in one embodiment the width dimension is approximately 7.5 inches and the length dimension is approximately 20.5 inches. In some embodiments the first perforated tear-off line and the first fold line coincide.

In another aspect of the invention a method for forming a two-way disk mailer is provided, comprising the steps of (a) defining first, second, third and fourth regions disposed left to right successively on a planar, rectangular sheet of foldable material having a left edge and a right edge defining a length substantially greater than a width, by placing first, second and third fold lines across the width of the sheet at right angles to the length such that the dimensions of the second and the third regions in the direction of the length of the sheet are substantially equal, the dimension of the first region in the same direction is greater than that of any of the four regions, and the dimension of the fourth region in the same direction is less than that of any of the four regions; (b) forming a first perforated, tear-off line proximate the first fold line; (c) providing a first glue region, being either of a self-adhesive strip with a peel-off protective cover, or a stripe of remoistenable glue, at the left edge of the sheet in the direction of the width dimension and joined to the sheet by a second perforated tear-off line; (d) providing a second glue region, being either of a self-adhesive strip with a peel-off protective cover, or a stripe of remoistenable glue, at the right edge of the sheet in the direction of the width dimension; (e) placing a pattern of adhesive on the second region; and (f) folding the third region over the second region, adhering the third region to the second, forming a pocket to enclose a planar disk on three sides.

In one embodiment there is a further step for placing a disk in the pocket formed, folding the fourth region back over the pocket, folding the first region over the pocket and the fourth region, and folding the first glue region around the closed end of the pocket and sealing it to the opposite side, closing the pocket and completing the two-way disk mailer ready to be addressed and mailed. Also in one embodiment there is a step for tearing the package open at the perforated tear-off line at the first glue region that was used to seal the package, and folding the first region back away from the pocket, re-opening the pocket such that the disk may be removed.

In some embodiments of the method there is a step for placing a disk in the pocket, tearing off the first region at the first perforated tear-off line, and closing a sealing the pocket again by folding the fourth region to the opposite side of the pocket and sealing it there using the second glue region. Also in some embodiments the dimensions of the second and third regions is greater than five inches, such that the pocket formed in step (e) encloses a disk of five inches diameter.

### BRIEF DESCRIPTION OF THE DRAWING FIGURES

FIG. 1 is an elevation view of a pattern for creating a package for mailing computer-useable media according to an embodiment of the present invention.

FIG. 2 is a perspective view of the pattern of FIG. 1 showing direction of folds for forming a pocket to contain the computer-useable media according to an embodiment of the present invention.

FIG. 3 is an elevation view of the pattern of FIG. 1 folded over to form an open pocket 300 according to an embodiment of the present invention.

FIG. 4 is a perspective view of the pattern of FIG. 3 with an end fold positioned over the pocket to seal forming a package for mailing.

FIG. 5 is a perspective view of sealed package containing a computer-useable media for mailing according to an embodiment of the present invention.

FIG. 6 is a rear perspective view of the package of FIG. 5 illustrating opening of the pocket after a first mailing to retrieve the computer-useable media according to an embodiment of the present invention.

FIG. 7 is a perspective view of a new package with the first end fold removed and the pocket repacked and resealed using the remaining end fold according to an embodiment of the present invention.

FIG. 8 is a partial view of the pattern of FIG. 1 illustrating a die-cut version of the pattern.

FIG. 9 is a partial view of the die-cut pattern of FIG. 8 with the tabs folded over.

FIG. 10 is a perspective view of a pattern 1000 comprised of two assembled pieces according to an embodiment of the present invention.

### DETAILED DESCRIPTION

The inventors provide a unique package for mailing computer disks and the like that conforms with U.S. Postal regulations relating to the size, weight and shape of Automation-Compatible Folded Self-Mailers Containing Discs as set forth in the Domestic Mail Manual section 201 paragraph: 3.3.4 Dimensions and Shape Standards for Automation-Compatible Folded Self-Mailers Containing Discs. The package in embodiments of this invention enables users to receive disks in the mail and send them or others back through the mail using the same package. The present invention is described in enabling detail using the examples laid out herein, which may illustrate one or more embodiments of the present invention.

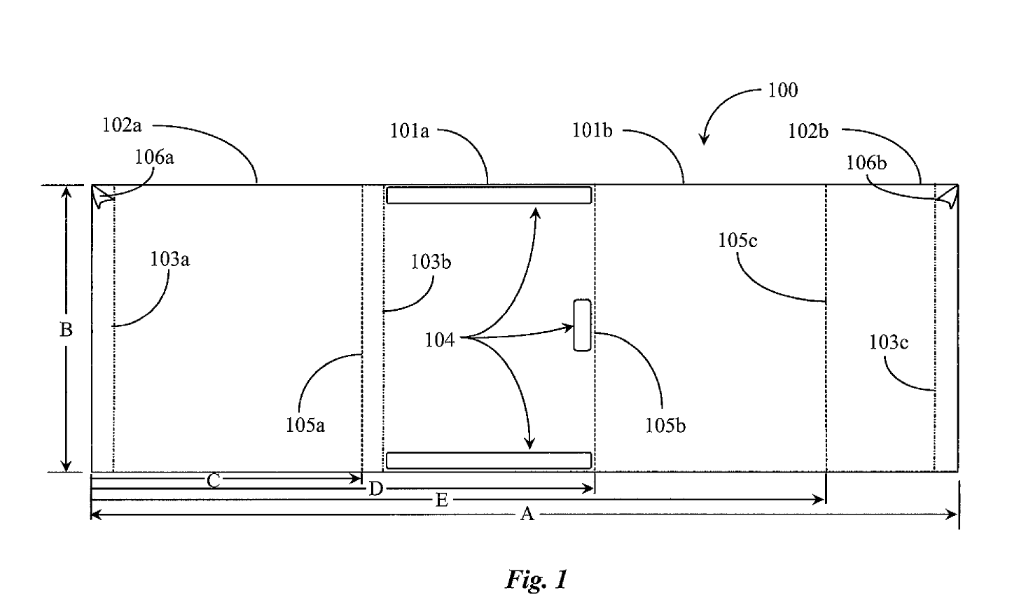

FIG. 1 is an elevation view of a patterned form 100 for creating a package for mailing computer-useable media according to an embodiment of the present invention. Form 100 is rectangular having a length dimension A and a width dimension B. Length dimension A is substantially greater than width dimension B. In one embodiment length dimension A is approximately 20.5 inches and dimension A is approximately 7.5 inches. Although other dimensions may be used for pattern 100, these specific dimensions facilitate creation of a package for mailing computer-useable media such as standard compact disks (CDs) or digital video disks (DVDs) that conforms to a U.S. Post Office specification listed in the background section of this specification. Although a pattern thickness is not specifically illustrated in this example, in one embodiment, form 100 is cut from 75# uncoated offset paper. Other grades of paper may be substituted therefor without departing from the spirit and scope of the present invention.

Form 100 is strategically divided into 4 linear regions separated by three fold lines. As is known in the art, fold lines are creases in the paper that facilitate and guide folding the form at these lines. These regions include two center regions 101a and 101b, and two end regions 102a and 102b respectively. The regions are defined by three fold lines strategically placed along the length of form 100.

In this example the fold lines run vertically to the length of the form and include a fold line 105a, which is illustrated at a dimension C from the left edge of the form. In one embodiment dimension C is approximately 6.5 inches. A second fold line 105b is illustrated at a dimension D from the left edge of the form. In one embodiment dimension D is approximately 12 inches from the left edge of the form. A third fold line 105c is illustrated at a dimension E from the left edge of the form. In one embodiment dimension E is approximately 17.5 inches.

Center region 101a and center region 101b are joined at fold line 105b, and are substantially identical in dimension. In one embodiment center fold 101a and 101b are 5.5 inches in length. Center regions 101a and 101b will form walls of a pocket that will be used to contain computer-useable media for mailing, such as one or more CDs and or DVDs. End region 102a is the longer of the two defined end regions. In one embodiment end region 102a is approximately 6.5 inches in length, while end region 102b is approximately 3 inches in length. The dimensioning cited in this specification is exemplary only and in one embodiment promotes creation of a package that confirms to dimensional standards previously mentioned. However, in some embodiments other dimensions may be used in similar applications whether or not conformance with a U.S. postal standard is sought. Therefore all of the dimensions cited in this specification should not be construed as limiting, rather merely enabling.

Form 100 includes a self-sealing adhesive strip 107a joined to region 102a by a perforated tear-off line 103a orientated vertically in the direction of the width dimension of the form and disposed at the left edge of the form. Strip 107a is approximately 0.5 inches wide measured from the left edge of the form. As is known in the art, such perforated lines facilitate tearing along the line to separate on region from others of such a form, but may also serve as fold lines. Form 100 includes a second self-sealing adhesive strip 107b disposed along the opposite edge of the form from strip 107a. Strip 107b is approximately 0.5 inches in width measured from the right edge of the form. A perforated line 103c joins self sealing strip 107b to the rest of the form, also serving both as a fold line and as a tear-off line. An additional perforated line 103b is provided near fold line 105a, as shown. In one embodiment lines 105a and 103b coincide, such that this line is also both a fold line and a perforated, tear-off line.

Strips 107a and 107b may be more than 0.5 inches wide or less than 0.5 inches wide without departing from the spirit and scope of the present invention. In this example the adhesive side of each glue strip faces the viewer in this elevation view. In a preferred embodiment, adhesive strips 107a and 107b have peel-back strip covers 106a and 106b to protect the adhesive surfaces. In one embodiment, glue strips 107a and 107b are replaced with a like pattern of remoisten able glue.

A bead or otherwise a pattern of adhesive 104 is provided on the surface of center region 101a in this example for the purpose of promoting adhesion of the surface to a facing surface of the adjacent center region 101b when the form is folded over fold line 105b to form a pocket for containing a computer-useable media, more particularly a CD or DVD. Adhesive deposit 104 is deposited adjacent to three sides of center region 101a leaving one side open for forming the opening of the pocket. In one embodiment, the adhesive occupies up to approximately 2 inches of width dimension B from the edge in on opposing sides, which in one embodiment leaves about 5.5 inches of useable pocket.

The adhesive occupies up to about 0.5 inches from fold line 105b leaving approximately 5 inches for the depth of the pocket measured from the opening of the pocket. In one embodiment adhesive bead 104 is placed adjacent to opposite edges defining the width dimension but no adhesive is applied adjacent to fold line 105b. In one embodiment adhesive 104 comprises two opposing strips and a smaller rectangular deposit adjacent to line 105b In another embodiment some other fastening method is used instead of adhesive to form the pocket such as staples, for example. In one embodiment of the present invention form 100 is plastic instead of paper.

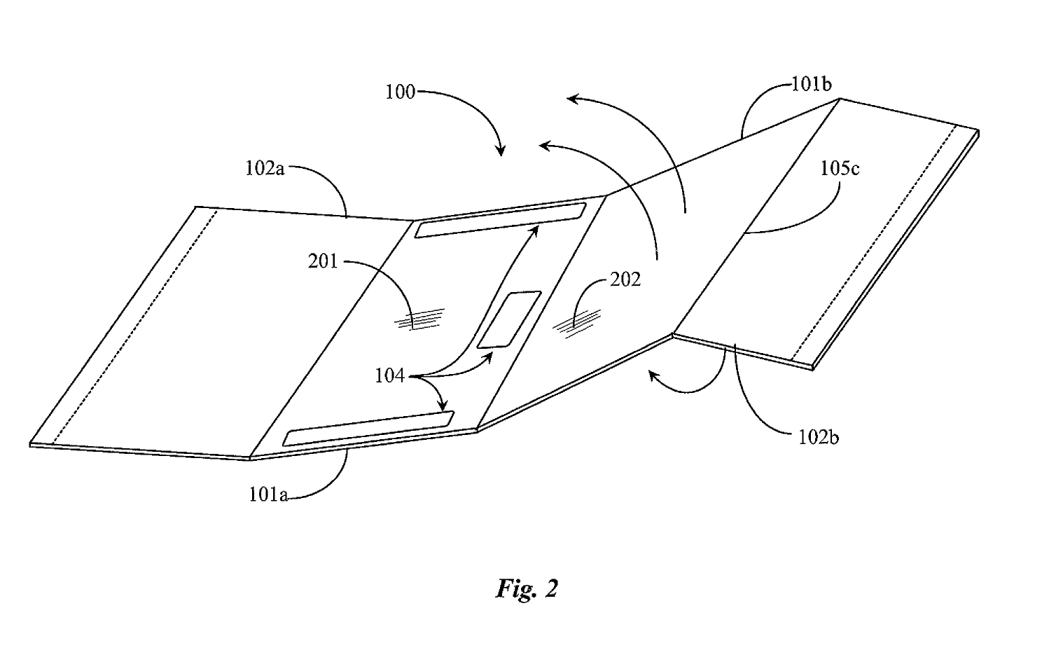

FIG. 2 is a perspective view of form 100 of FIG. 1 showing direction of folds for forming a pocket to contain the computer-useable media according to an embodiment of the present invention. Center region 101b is folded over onto center region 101a and against adhesive bead 104 to secure the formation of the pocket. In this embodiment a surface 201 of center fold 101a becomes an inside wall of the pocket. Surface 202 of center fold 101b becomes the other inside wall of the pocket formed during the folding process in the construction of a two-way mailer package.

End region 102a is somewhat (about 0.5 inches) longer than the linear dimension (5.5 inches) of center regions 101a and 101b such that it more than covers the dimension after the form is folded over fold line 105b. When the fold is made surfaces 201 and 202 are pressed together with adhesive 104 situated there between to form the pocket. End fold 102b is folded back (clockwise as shown) to be used later in the second use of the two-way mailer created. End region 102b rests against the back side of center region 101b.

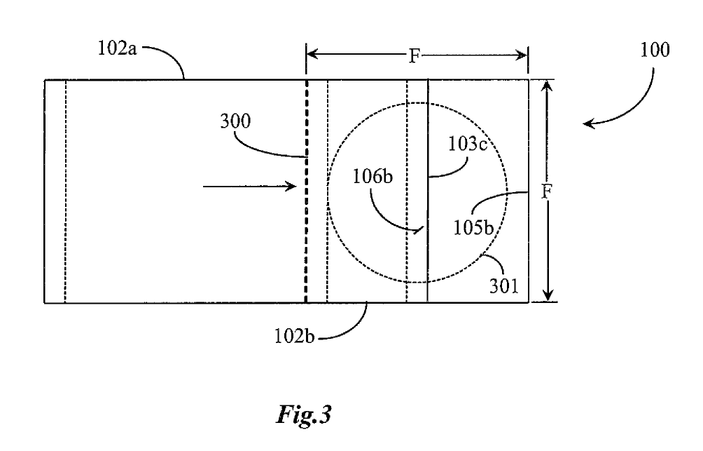

FIG. 3 is a plan view of from 100 of FIG. 1 folded over to form an open pocket 300 according to an embodiment of the present invention. Pocket 300 has an outside width of about 7.5 inches and an inside or pocket width of about 5.5 inches suitable for inserting a standard DVD or CD of about 5 inches in diameter.

Pocket 300 has a depth as measured from the pocket opening of about 5.5 inches suitable for enclosing a CD or DVD therein without exposing the edge of the CD or DVD through the opening. In this example, end region 102b is folded back over pocket 300 with the adhesive side of adhesive strip 107b facing upward and covered by the strip cover or liner 106b. It is noted herein that end region 102b is not glued or otherwise fixed to the side of pocket 300 at this point. End fold 102a has not yet been folded at this point in this example, which allows for unobstructed inserting of a CD or DVD into the pocket. A CD or DVD 301 is illustrated within pocket 300 for reference.

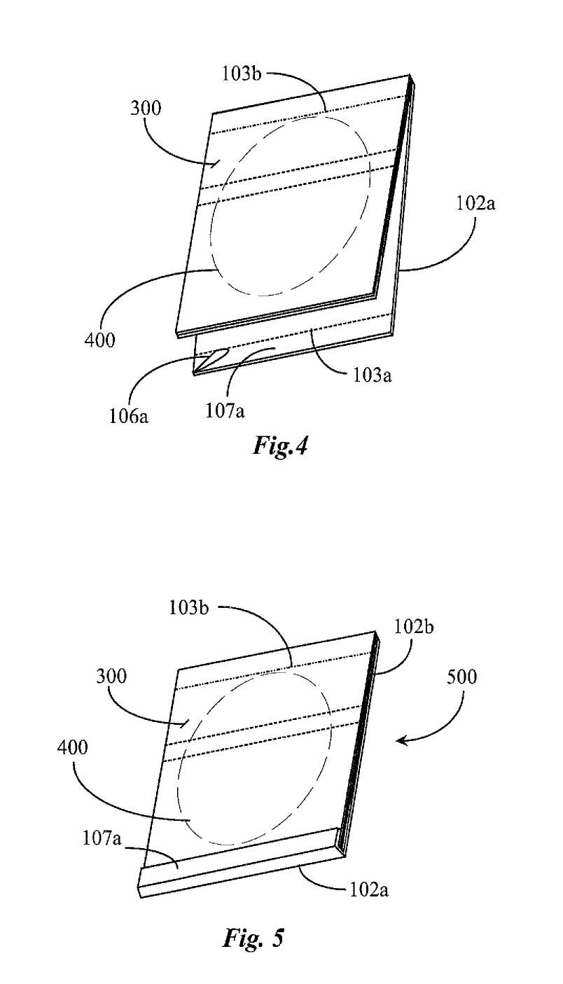

FIG. 4 is a perspective view of form 100 of FIG. 3 with end region 102a positioned over the pocket, forming a package 500 for mailing. Adhesive strip 107a is shown as extending beyond the end of the pocket. FIG. 5 is a perspective view of sealed package 500 containing a computer-useable media for mailing according to an embodiment of the present invention.

Referring again to FIG. 4, a package is formed having pocket 300 with a CD or DVD 400 contained therein for mailing. The viewing reference of FIG. 4 is from the rear compared to the viewing reference of FIG. 3. End region 102a is at this point folded over the pocket formed by regions 101a and 101b. Before sealing the package for mailing, a user removes glue strip liner 106a to expose the self-sealing adhesive surface of self-sealing adhesive strip 107a. Strip 107a is then folded around the edge of the package and can be pressed against the surface (back of pocket) to close the package. The opening into pocket 300 is opposite the seal formed by region 107a.

Referring now to FIG. 5, a completed package 500 is illustrated, completely sealed. Disk 400 is contained within the package, more particularly within pocket 300. End region 102b lies within the package, reserved for resealing pocket 300 for a second mailing using the same package. Package 500 may be addressed on the outside surface of end region 102a opposite seal 107a for mailing by attaching a suitable mailing label or otherwise providing the mailing address information.

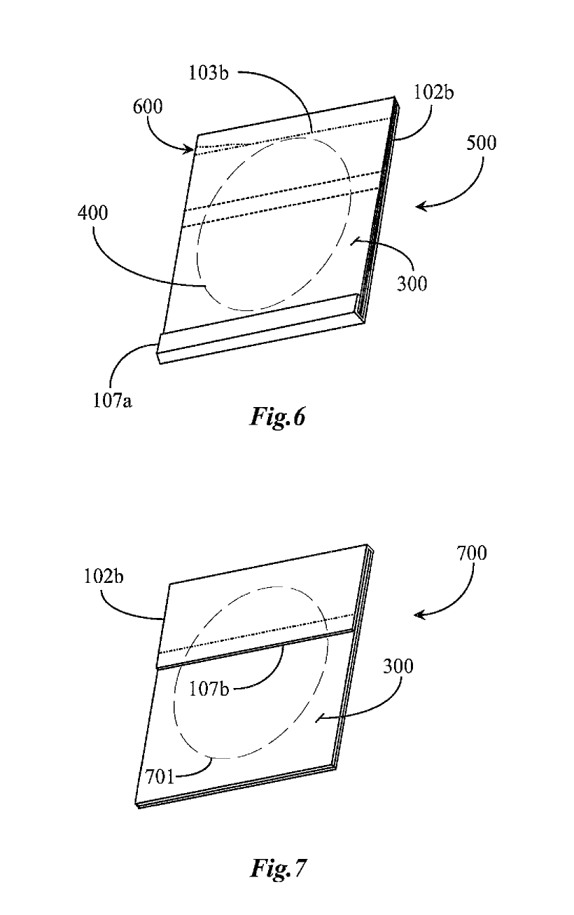

FIG. 6 is a rear perspective view of package 500 of FIG. 5 illustrating opening of the pocket after a first mailing to retrieve the computer-useable media according to an embodiment of the present invention. FIG. 7 is a perspective view of a new package 700 with the first end region 102a removed, the pocket repacked and resealed using the remaining end region 102b according to an embodiment of the present invention.

Referring now to FIG. 6, package 500 may be opened after a first mailing by breaking perforated line 103b as is illustrated in this example by opening 600. Perforated line 103b is near the opening of pocket 300 defined by fold line 105a as was described with reference to FIG. 1 pattern 100. In an alternative embodiment a user receiving package 500 may open the package by removing the first end region used to seal the package, namely end region 102a. Perforated lines 103a and 103b (FIG. 1) facilitate this step. The user opens by tearing along the perforated lines and removing region 102a leaving strip 107a attached.

Referring now to FIG. 7, a new package 700 is created for a second use by removing region 102a after the first mailing. Region 102a is removed and discarded and therefore not illustrated in this example. With region 102a removed, region 102b becomes available to use for resealing the package. From its neutral position behind the package in this view, region 102b may be folded back around the opening of pocket 300 and sealed against the outside surface of region 101a. It is presumed in this example that a new CD or DVD 701 is placed into pocket 300 before re-sealing the package using self-adhesive strip 107b with the strip cover or liner removed.

Package 700 is lighter in weight that package 500 resulting from removal of the region 102a. To open the second version of the package a user may tear at the perforated line bounding self-adhesive strip 107b. Hence the package of the present invention can be used twice for mailing. A new addressing label may be placed over the outside surface of center fold 101b.

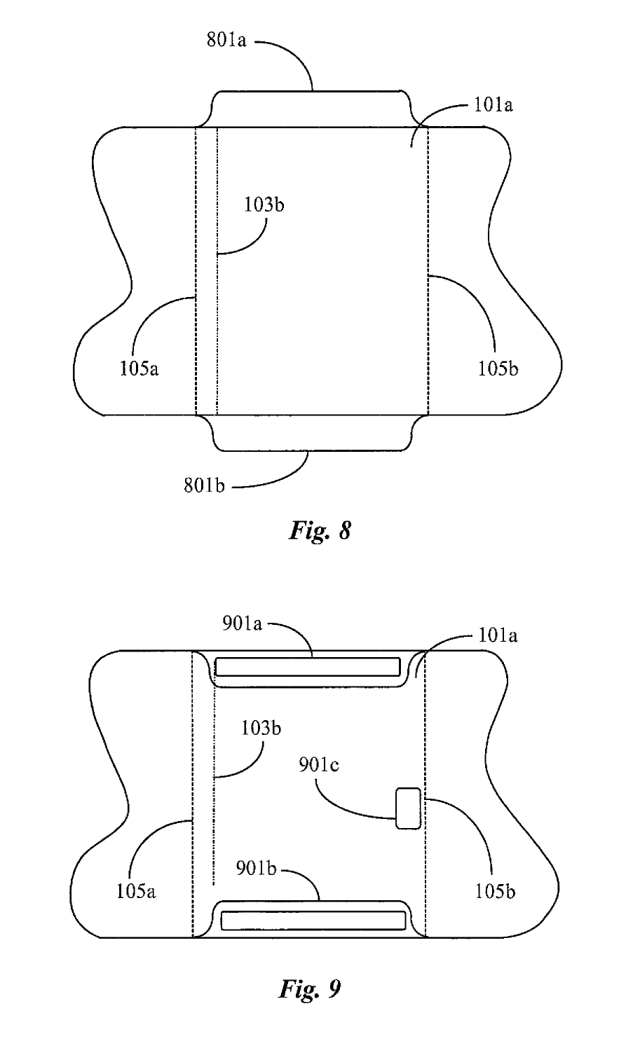

FIG. 8 is a partial view of a die-cut version of the pattern of FIG. 1 illustration region 101a. In this example the pattern used for making the mailer of the present invention is die-cut and includes fold-over tabs 801a and 801b. Fold over tabs 801a and 801b are adapted to be folded over the edges of the pattern at region 101a as shown further below.

FIG. 9 is a partial view of the die-cut pattern of FIG. 8 with the tabs folded over. In one embodiment tabs 801a and 801b are folded over and adhesive glue stripes 901a and 901b are deposited thereon. A deposit of glue 901c is then deposited on the surface of region 101a. Remoisten able glue may be used in place of the glue strips. In this example, the tabs are folded over before a fold is made at fold line 105b to secure the pocket for enclosing a planar disk.

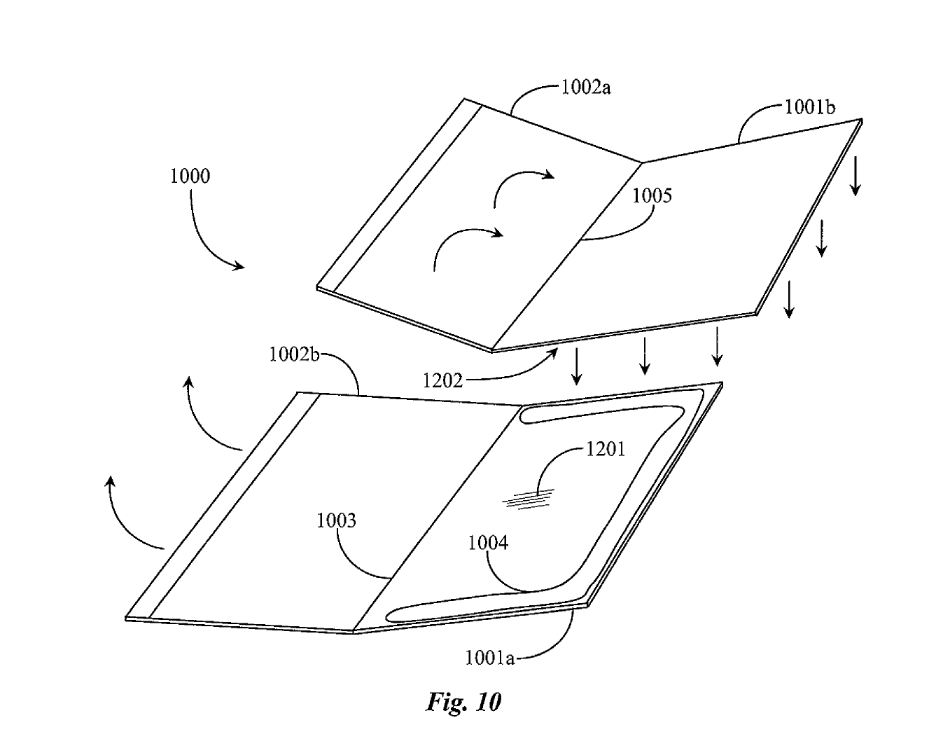

FIG. 10 is a perspective view of a pattern 1000 comprised of two assembled pieces according to an embodiment of the present invention. Pattern 1000 includes two pieces that are glued together to form the basic mailer. A first piece of pattern 1000 is represented by a section 1002b and a section 1001a that share a fold line 1003. The first piece of pattern 1000 is analogous in dimension and form to regions 102b and 101a of pattern 100 of FIG. 2. In this example a U-shaped pattern of glue is deposited on surface 1201.

The second piece of pattern 1000 is represented by a section 1002a and a section 1001b that share a fold line 1005. The second portion of pattern 1000 is press glued to the first portion of the patterns bringing a surface 1202 of section 1001b together against surface 1201 according to the directional straight arrows such that the bottom edge (bottom of pocket) and side edges (side of pocket) are relatively flush when fully glued together. In this example section 1002a is folded back over the assembly in the direction of the directional arcuate arrows. Section 1002b is finally folded over the entire package according to the directional arcuate arrows where it may be fastened to the back surface of section 1001b, namely surface 1202 to seal the package. When the package has its content removed, it may be reloaded with the same or another planer disk and section 1002a may then be used to seal the package again as was described further above with respect to the singular pattern of FIGS. 1 and 2.

In one embodiment of the invention the mailer of the invention can be used to receive and return DVDs through the mail. In another embodiment the mailer is used to mail and return data CDs in a peer review process. It will be apparent to one with skill in the art that the two-way mailer of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A form for creating a two-way mailer, comprising:
a planar, rectangular sheet of foldable material having a left edge and a right edge defining a length substantially greater than a width;
first, second, third and fourth regions disposed left to right successively on the sheet, the regions defined by first, second and third fold lines across the width of the sheet at right angles to the length;
a first perforated tear-off line proximate the first fold line;
a first glue region at the left edge of the sheet in the direction of the width dimension and joined to the sheet by a second perforated tear-off line;
a second glue region at the right edge of the sheet in the direction of the width dimension; and
a pattern of adhesive on the second region;
wherein the dimensions of the second and the third regions in the direction of the length of the sheet are substantially equal, dimension of the first region in the same direction is greater than that of any of the other regions, and the dimension of the fourth region in the same direction is less than that of any of the other regions, and the first and second glue regions are one of remoistenable glue or self-adhesive regions with a peel-off cover.

2. The form of claim 1 wherein the dimensions of the second and the third regions in the direction of the length of the sheet are about 5.5 inches, and with the third region folded over the second region and adhered by the pattern of adhesive, provides for a pocket of a size to enclose a five-inch diameter planar disk.

3. The form of claim 1 wherein the width dimension is approximately 7.5 inches and the length dimension is approximately 20.5 inches.

4. The form of claim 1 wherein the first perforated tear-off line and the first fold line coincide.

5. A method for forming a two-way disk mailer, comprising the steps of:
(a) defining first, second, third and fourth regions disposed left to right successively on a planar, rectangular sheet of foldable material having a left edge and a right edge defining a length substantially greater than a width, by placing first, second and third fold lines across the width of the sheet at right angles to the length such that the dimensions of the second and the third regions in the direction of the length of the sheet are substantially equal, the dimension of the first region in the same direction is greater than that of any of the four regions, and the dimension of the fourth region in the same direction is less than that of any of the four regions;
(b) forming a first perforated, tear-off line proximate the first fold line;
(c) providing a first glue region, being either of a self-adhesive strip with a peel-off protective cover, or a stripe of remoistenable glue, at the left edge of the sheet in the direction of the width dimension and joined to the sheet by a second perforated tear-off line;
(d) providing a second glue region, being either of a self-adhesive strip with a peel-off protective cover, or a stripe of remoistenable glue, at the right edge of the sheet in the direction of the width dimension;
(e) placing a pattern of adhesive on the second region; and
(f) folding the third region over the second region, adhering the third region to the second, forming a pocket to enclose a planar disk on three sides.

6. The method of claim 5 further comprising a step for placing a disk in the pocket formed, folding the fourth region back over the pocket, folding the first region over the pocket and the fourth region, and folding the first glue region around the closed end of the pocket and sealing it to the opposite side, closing the pocket and completing the two-way disk mailer ready to be addressed and mailed.

7. The method of claim 6 further comprising a step for tearing the package open at the perforated tear-off line at the first glue region that was used to seal the package, and folding the first region back away from the pocket, re-opening the pocket such that the disk may be removed.

8. The method of claim 7 further comprising a step for placing a disk in the pocket, tearing off the first region at the first perforated tear-off line, and closing a sealing the pocket again by folding the fourth region to the opposite side of the pocket and sealing it there using the second glue region.

9. The method of claim 5 wherein the dimensions of the second and third regions is greater than five inches, such that the pocket formed in step (e) encloses a disk of five inches diameter.
